(19) United States
(12) Patent Application Publication
(10) Pub. No.: US 2011/0111684 A1
(43) Pub. Date: May 12, 2011

(54) BLOW DEVICE FOR REAR VIEW MIRROR OF A VEHICLE

(76) Inventor: Jianzhong Wang, Fujian (CN)

(21) Appl. No.: 13/003,424

(22) PCT Filed: Aug. 4, 2008
(86) PCT No.: PCT/CN2008/071863

§ 371 Date: Jan. 10, 2011

(51) Int. Cl. B60S 1/54

(52) U.S. Cl. 454/121

(57) ABSTRACT

A blow device for rear view mirror of a vehicle includes a control circuit (1), an air compressor (2), an air duct (3) and a blow nozzle (4). The operation of the air compressor (2) is controlled by the control circuit (1). The air outlet of the air compressor (2) is connected to the blow nozzle (4) via the air duct (3). The blow nozzle (4) is mounted on the vehicle facing the rear view mirror (10) and the side window (20) for removing the fog and water droplets on there. A sensor (7), as well as a compression frequency adjuster (6) and/or an air exhausting frequency adjuster (9) are added to the blow device. The sensor (7) is used to detect the swing frequency of the wiper (8) as a detected signal. The control circuit (1) processes the detected signal to generate an adjusting signal and then transmits the adjusting signal to the compression frequency adjuster (6) and/or the air exhausting frequency adjuster (9) respectively. The compression frequency of the air compressor (2) is controlled by the compression frequency adjuster (6) based on the adjusting signal, and the air exhausting frequency of the blow nozzle (4) is controlled by the air exhausting frequency adjuster (9) also based on the adjusting signal, so that the blow amount can be automatically adjusted depending on the precipitation rain fall.

### FIELD OF THE INVENTION

The invention relates to a blow device for rear view mirror of a vehicle, which is applicable to all kinds of vehicles to remove the fog and water droplets on the rear view mirrors and the corresponding windows.

### DESCRIPTION OF RELATED ART

In today's society, the technology develops rapidly, the quality of people's living rises continuously, and the pace of working and living becomes progressively faster, therefore, in order to enjoy a high quality of living sufficiently, accommodate to the fast pace and save time, more and more people choose to buy a car, and it has become a trend to take a car instead of walking.

When driving, safety is the first thing to be concerned. However, the safety of vehicles will be decreased greatly while driving in rain, and the reason, what is well known, mainly lies in slippery road in rainy days and bad sight; particularly in a wet day, the humidity outside of the vehicle is high, the temperature difference is great between inside and outside of the car, thereby humid air easily forms the fog and water droplets on the car windows (including front and rear windscreens, and side windows) or on the rear view mirrors. The fog and water droplets coating the surface of the rear view mirrors and corresponding car windows make the car windows and the rear view mirrors obscure and thereby further influence the sight of a driver. For example, the fog and water droplets are formed on the rear view mirrors and the corresponding car windows, so that a driver cannot observe the rear view mirrors through the side windows in backing, steering, or lane-changing, and thereby it is impossible to judge and determine the situation around the car body, which brings inconvenience to driver's driving and may even cause a traffic accident.

In this regard, the inventor adds blow devices adjacent to the rear view mirrors and the side windows of a vehicle, so as to blow away the fog and water droplets in time in rainy days, and thereby making the sight of the driver clearer and facilitating safe driving, and further avoiding the occurrence of traffic accidents. Therefore, the present application is provided.

### SUMMARY OF THE INVENTION

The present invention aims to provide a blow device for rear view mirror of a vehicle, which is applicable to all kinds of vehicles to remove the fog and water droplets on the rear view mirrors and the side windows, so as to make the sight much clearer.

In order to achieve the above object, the present invention provides the following solutions.

A blow device for rear view mirror of a vehicle comprises a control circuit, an air compressor, an air duct and a blow nozzle(s), the control circuit controls the operation of the air compressor, an air outlet of the air compressor is connected to the blow nozzle via the air duct, and the blow nozzle(s) is mounted on the vehicle facing the rear view mirror and the side window.

There are two blow nozzles, one is mounted on the mirror frame facing the rear view mirror, and the other is mounted on the support of the rear view mirror facing the side window.

The blow device further comprises a compression frequency adjuster and a sensor, wherein the sensor is used to detect the swing frequency of the wiper, and sends a signal to the control circuit, the control circuit processes the signal and then transmits an adjusting signal to the compression frequency adjuster, and the compression frequency adjuster controls the compression frequency of the air compressor based on the adjusting signal.

The blow device further comprises an air exhausting frequency adjuster and a sensor, wherein the sensor is used to detect the swing frequency of the wiper, and sends a signal to the control circuit, the control circuit processes the signal and then transmits an adjusting signal to the air exhausting frequency adjuster, and the air exhausting frequency adjuster controls the air exhausting frequency of the blow nozzle based on the adjusting signal.

The blow device further comprises a heater between the air compressor and the air duct.

A vehicle is equipped with a device of the present invention applying the above configuration. When the driver activates the front window wiper while driving in rainy days, the device can be started. The control circuit controls the air compressor to operate, the air produced by the air compressor is blown out from the blow nozzle through the air duct towards the rear view mirror and the side window so as to disperse the fog and water droplets on the rear view mirror and the side window to keep the rear view mirror always clear and the side window always transparent, thereby the driver can observe the rear view mirror through the side window in backing, steering, or lane-changing to determine the situation around the car body. To keep a clear field of vision is more advantageous for safe driving and therefore avoiding a traffic accident.

### BRIEF DESCRIPTION OF THE DRAWINGS

FIG. 1 is a schematic view illustrating the configuration of a blow device according to an embodiment of the present invention;

FIG. 2 is a schematic view illustrating a vehicle to which a blow device according to an embodiment of the present invention is mounted; and

FIG. 3 is an enlarged view of FIG. 2.

### MEANINGS OF REFERENCE NUMBERS

control circuit 1,
air compressor 2,
air duct 3,
blow nozzle 4,
heater 5,
compression frequency adjuster 6,
sensor 7,
wiper 8,
air exhausting frequency adjuster 9,
rear view mirror 10,
side window 20,
mirror frame of the rear view mirror 30,
support 40.

### DETAILED DESCRIPTION OF PREFERRED EMBODIMENT

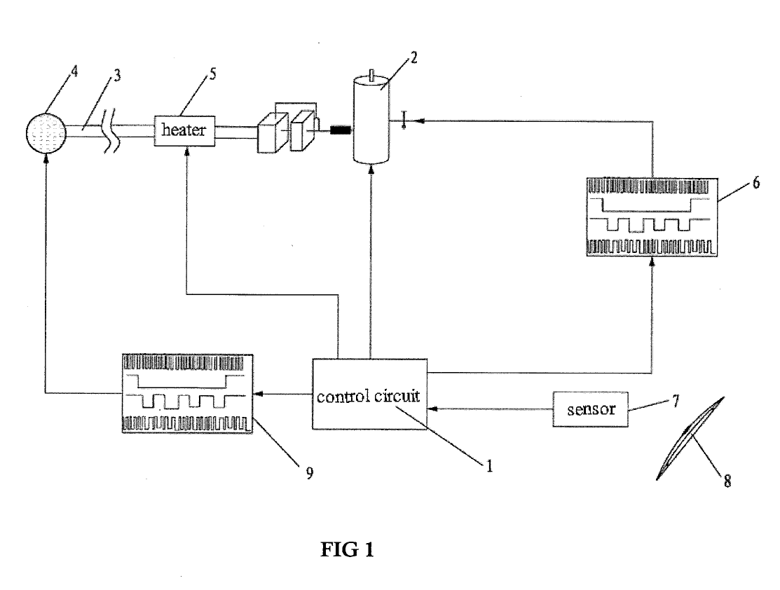

FIG. 1 shows the preferred embodiment of the present invention. As shown in FIG. 1, a blow device for rear view mirror of a vehicle comprises a control circuit 1, an air compressor 2, an air duct 3 and a blow nozzle 4.

Wherein, the control circuit 1 controls the operation of the air compressor 2, and can be arranged on any position in the vehicle invisibly according to the design requirement.

The air compressor 2 can also be arranged on any position in the vehicle invisibly according to the design requirement.

The air duct 3 is arranged in the vehicle invisibly. One end of the air duct 3 is connected to the air outlet of the air compressor 2, and the other end thereof is connected to the blow nozzle 4.

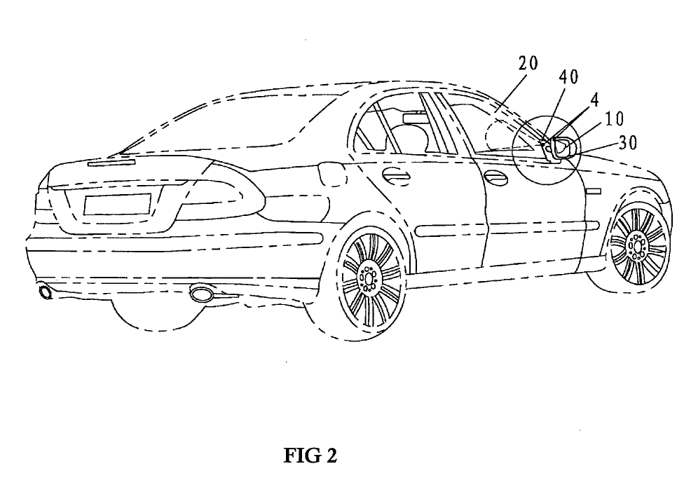

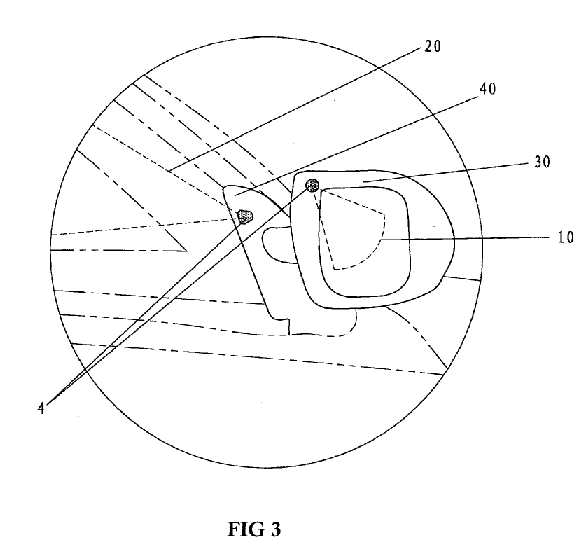

As shown in FIGS. 2 and 3, the blow nozzle 4 is mounted on the vehicle facing the rear view mirror 10 and the side window 20. In order to blow away the fog and water droplets, there are two blow nozzles 4 in this embodiment, one is mounted on the mirror frame 30 facing the rear view mirror 10, and the other is mounted on the support 40 of the rear view mirror 10 facing the side window 20.

In order to blow away the fog and water droplets more quickly, a heater 5 is also arranged between the air compressor 2 and the air duct 3 in this embodiment, as shown in FIG. 1, the operation of the heater 5 can be controlled by the control circuit 1 as well, so that the heat air blown out from the blow nozzle 4 can make the fog and water droplets dispersed and dry more quickly to achieve better effect.

The present invention may also provide a compression frequency adjuster 6, an air exhausting frequency adjuster 9 and a sensor 7. As shown in FIG. 1, the sensor 7 is used to detect the swing frequency of the wiper 8, and sends a detected signal to the control circuit 1. The control circuit 1 processes this detected signal and then transmits an adjusting signal to the compression frequency adjuster 6 and the air exhausting frequency adjuster 9 respectively. The compression frequency adjuster 6 controls the compression frequency of the air compressor 2 based on the adjusting signal, and the air exhausting frequency adjuster 9 controls the air exhausting frequency of the blow nozzle 4 based on the adjusting signal. In this way, when the wiper 8 swings fast, i.e., in heavy rain, the compression frequency of the air compressor 2 is fast and the blowing frequency of the blow nozzle 4 becomes slow, thereby the wind blown out is strong; and when the wiper 8 swings slowly, i.e., in light rain, the compression frequency of the air compressor 2 is slow and the blowing frequency of the blow nozzle 4 becomes fast, thereby the wind blown out is small. In a conclusion, this device can automatically adjust the blow amount depending on the precipitation rain fall. It is more beneficial to drying of the frog and water droplets. In practical implementation, it is possible to only provide the compression frequency adjuster 6 and the sensor 7, or only provide the air exhausting frequency adjuster 9 and the sensor 7. This can be selected based on practical requirements and not limited to this embodiment described herein above.

In a word, a vehicle is equipped with a blow device according to the present invention. When the driver activates the front window wiper while driving in rainy days, the blow device can be started at the same time. The control circuit 1 controls the air compressor 2 to operate, the air produced by the air compressor 2 is blown out from the blow nozzle 4 through the air duct 3 towards the rear view mirror 10 and the side window 20, so as to disperse the fog and water droplets on the rear view mirror 10 and the side window 20 to keep the rear view mirror 10 always clear and the side window 20 always transparent and to make the sight of the driver clearer, thereby the driver can observe the rear view mirror 10 through the side window 20 in backing, steering, or lane-changing to judge and determine the situation around the car body. This is beneficial for safe driving and thus avoids a traffic accident.

The above embodiments are only for illustrating the technical solutions and features of the present invention rather than limiting the scope of the present invention. All equivalents, variations or modifications based on the spirit of the present invention should be within the scope of the present invention.

What is claimed is:

1. A blow device for rear view mirror of a vehicle, comprising: a control circuit, an air compressor, an air duct and a blow nozzle, the control circuit controls the operation of the air compressor, an air outlet of the air compressor is connected to the blow nozzle via the air duct, the blow nozzle is mounted on the vehicle facing the rear view mirror and the side window.

2. The blow device for rear view mirror of a vehicle of claim 1, wherein, the blow device comprises two blow nozzles, one is mounted on the mirror frame facing the rear view mirror, and the other is mounted on a support of the rear view mirror facing the side window.

3. The blow device for rear view mirror of a vehicle of claim 1, further comprising a compression frequency adjuster and a sensor, wherein the sensor is used to detect the swing frequency of a wiper, and sends a signal to the control circuit, the control circuit processes the signal and then transmits an adjusting signal to the compression frequency adjuster, and the compression frequency adjuster controls the compression frequency of the air compressor based on the adjusting signal.

4. The blow device for rear view mirror of a vehicle of claim 1, further comprising an air exhausting frequency adjuster and a sensor, wherein the sensor is used to detect the swing frequency of a wiper, and sends a signal to the control circuit, the control circuit processes the signal and then transmits an adjusting signal to the air exhausting frequency adjuster, and the air exhausting frequency adjuster controls the air exhausting frequency of the blow nozzle based on the adjusting signal.

5. The blow device for rear view mirror of a vehicle of claim 1, further comprising a heater arranged between the air compressor and the air duct.
